(19) United States
(12) Patent Application Publication
(10) Pub. No.: US 2011/0139264 A1
(43) Pub. Date: Jun. 16, 2011

(54) Fluid Handling System

(75) Inventor: Matthew R. Kuwatch, Uniontown, OH (US)

(73) Assignee: LUBRIZOL ADVANCED MATERIALS, INC., Cleveland, OH (US)

(21) Appl. No.: 12/964,799

(22) Filed: Dec. 10, 2010

Related U.S. Application Data
(60) Provisional application No. 61/286,405, filed on Dec. 15, 2009.

(51) Int. Cl. F15D 1/02; F16K 15/00

(52) U.S. Cl. 137/14; 137/511

(57) ABSTRACT

A fluid handling system is operative to deliver water based fluid through a plurality of plastic pipes and fittings to a plurality of fire suppression sprinkler heads (12). The fluid handling system includes a plurality of fittings (14, 16, 18, 20, 22). The fittings are joined in the system in cemented relation. The fittings and pipes are comprised of chlorinated polyvinyl chloride (CPVC) that is suitable for fire suppression applications. The failure of an installer to connect one or more fittings in the system in cemented relation is detectable through use of an apparatus (24). The apparatus operates to detect uncemented connections while avoiding pressurizing the system above a limit.

CROSS REFERENCE

This application claims priority from U.S. Provisional Application Ser. No. 61/286,405 filed on Dec. 15, 2009.

### TECHNICAL FIELD

This invention relates to fluid handling systems which may be classified in U.S. Class 137.

### BACKGROUND OF THE INVENTION

Fluid handling systems are used to distribute fluids from a source to one or more desired points of delivery. Many buildings include systems that operate to distribute water or water-based fluids to fixtures or other devices. It is becoming more common to use plastic pipe and fittings for fluid handling systems within buildings.

Many buildings require fire suppression sprinkler systems. Such systems commonly deliver water or a water-based fire extinguishing fluid. Sprinkler heads are connected to the system in various areas of the building. Sprinkler heads commonly include a valve or other mechanism that causes the sprinkler head to open in response to excess heat. When the sprinkler head opens, it delivers water which extinguishes the fire.

It is becoming more common to use specialized plastic piping and fittings in fluid handling systems for sprinklers. Certain types of pipes and fittings comprised of chlorinated polyvinyl chloride (CPVC) have been certified as suitable for use in such applications. CPVC piping and fittings suitable for fire suppression systems are marketed under the trademark BlazeMaster® and are comprised of materials provided by Lubrizol Advanced Materials, Inc., the assignee of the present invention.

The piping systems including plastic pipe fittings and couplings are assembled by joining the components in cemented connection. Suitable solvent cements and other adhesives, such as epoxy, are used for joining plastic pipes and fittings in cemented connection. Fittings commonly used in such systems include unions, tees, couplings, plugs, crosses, elbows and caps. The pipes and fittings are preferably made to maintain close tolerances. This enables the solvent cement which holds a fitting in joined connection in the system to also effectively plug any leak paths in the area of the joint when the fitting is properly included in the system. Further, some fittings have tapered contours so as to further effectively ensure that the fittings do not leak when they are joined in cemented connection in the system.

Often when a piping system such as a sprinkler system is being installed, the installer will cut the pipe sections to length and assemble the fittings without cementing the components together. This is done initially to be sure that the system components are of the proper length and that all of the components fit together to form the desired fluid handling system. This enables the installer to make any adjustments at this time such as shortening or lengthening pipe runs or adding additional fittings so as to produce the desired system. During this process the fittings and pipe are assembled in a “dry fit” without cement so that the pipes and fittings can be disassembled should there be any need to make changes. When the installer is satisfied with the piping system, he or she will then disassemble the pipe lengths and fittings and then reassemble them permanently joining them together using cement.

As can be appreciated, because there are often so many fittings that need to be joined in cemented relation in the system, occasionally mistakes are made. An installer may occasionally forget to apply cement to a particular fitting surface. This particular fitting may be held in place in the system in a dry fit. It may not be readily apparent that the particular fitting is not cemented in place. This can be particularly true for fittings that have a configuration which provides a firm dry fit due to the nature and tapered configuration of the particular fitting.

Piping systems and particularly those involving sprinklers are tested after assembly for leaks. Testing is done using water or water-based fluid (for purposes of brevity, water and water-based fluids will be referred to hereinafter as simply water). Water testing involves filling the pipes in the system with water. As this is done, air is vented out of the pipes generally at the highest point or from several points as appropriate through valves or other vents to assure that the system is filled with water. Once all of the pipes and fittings are filled with water, the valves or vents are closed and pressure is applied to the water and held for a period of time to evaluate whether there are any leaks.

If leaks are found, such as due to an uncemented fitting connection (a “dry fit”) or for other reasons, the water must be drained and the problem corrected. In the case of CPVC sprinkler systems, great care must be taken to assure that all of the water is removed from the system. This often involves extensive efforts to dry all or portions of the system in which the leak has occurred as the presence of water can interfere with the proper cemented connection of the components. This process can be time consuming and once it is completed and sufficient time is allowed for the cement applied as part of the repair to cure, the process must then be repeated.

While water testing of fluid handling systems such as sprinkler systems including CPVC pipes and fittings will often uncover instances of dry fits, this is not always the case. This is because the dry fits even though they have not been properly cemented, are nonetheless water tight and do not show evidence of leakage during the water pressure test. As a result, such dry fits can often go undetected for some time after the system is placed in service. Sometimes a substantial period later after the building is occupied, conditions may occur which cause the uncemented connections to open. The result can be flooding and extensive water damage.

Therefore, fluid handling systems and particularly sprinkler systems that include CPVC pipes and fittings may benefit from improvements.

### OBJECTS OF EXEMPLARY EMBODIMENTS

It is an object of an exemplary embodiment to provide an improved fluid handling system.

It is an object of an exemplary embodiment to provide an improved fluid handling system that includes a piping system that includes plastic fittings.

It is a further object of an exemplary embodiment to provide an improved fluid handling system that reduces the risk of placing a system in service that includes plastic fittings with dry fits.

It is a further object of an exemplary embodiment to provide an improved fluid handling system that includes a sprinkler system comprised of CPVC pipes and fittings.

It is a further object of an exemplary embodiment to provide a method for assembling a fluid handling system that includes plastic fittings.

It is a further object of an exemplary embodiment to provide a method for testing a fluid handling system that includes a sprinkler system with CPVC fittings, for dry fits.

Further objects of exemplary embodiments will be made apparent in the following Detailed Description of Exemplary Embodiments and the appended claims.

The foregoing objects are accomplished in an exemplary embodiment by a fluid handling apparatus that is used in connection with a piping system that includes a plurality of plastic fittings joined in the system in cemented relation. In some exemplary embodiments, the piping system may include a sprinkler system comprised of CPVC pipes and fittings. The fittings are joined in the system in cemented relation using solvent cement. However, occasionally oversights result in dry fits where solvent cement has not been used to join the fittings in the system.

In an exemplary embodiment, dry fits are detected using an apparatus that can be releasibly connected to the piping system. The apparatus includes a fluid conduit. The fluid conduit can be pressurized with air through a pressure coupling connected to the fluid conduit. The pressure coupling is releasibly connectable to a source of pressurized gas such as an air compressor, pressure bottle or other suitable source. The fluid conduit is further in connection with a pressure indicator. The pressure indicator indicates the fluid pressure of the gas applied to the piping system through the fluid conduit. The pressure indicator may include a gauge which indicates the pressure in PSIG or other units.

The apparatus further includes a valve that is in fluid connection with the fluid conduit. The valve is preferably a manually actuatable valve that can be selectively operated to relieve pressure from the fluid conduit and the piping system. The exemplary embodiment further includes a pressure relief valve in operative connection with the fluid conduit. The pressure relief valve operates to relieve pressure above a set limit. This avoids over pressurizing the system in ways that can be dangerous or may cause system damage. In some exemplary embodiments, the pressure relief valve may include a frangible member such as a burst disc that breaks and/or relieves the pressure when the pressure reaches the limit.

In an exemplary method, a piping system is assembled by arranging and cementing the pipes, fittings and other components so as to form the piping system. Once the piping system is formed, any valves or other fluid escape points are closed. The fluid conduit is then fluidly connected to the piping system through a system coupling, and the fluid conduit is pressurized through the pressure coupling from the source of pressurized gas. The system is pressurized to a suitable test pressure. For example, for certain CPVC sprinkler systems, a suitable test pressure may be approximately 15 PSIG. Once the system is pressurized to the test pressure, no further gas is introduced. The pressure indicator is then observed to determine if the piping system holds the test pressure through a test period. The test period may be a matter of several hours or a period of one or more days depending on the requirements of the particular system.

If the system holds pressure for the duration of the test period, or the losses indicated are found to be minimal or within suitable limits, the gas pressure can then be relieved from the system by opening the manual valve attached to the fluid conduit. Alternatively, if the system fails to hold pressure, the source of leakage can be detected. This can be done in numerous ways such as by using listening devices, bubbling type leak detector solutions or other suitable detectors to determine the point of the leak. The leak point can then be determined and repaired.

It should be appreciated that leakage of air or other types of gases will more likely occur at dry fits, and dry fits are more likely to be detected through the use of pressurized gas than when using water for testing. Further, when a leak is found using pressurized air or other gas testing, the need to drain the system and dry the system or at least the area where the leak has occurred, can often be avoided or at least minimized.

It should be mentioned that pressure testing with compressed gas, such as air, of systems including CPVC fittings and other plastic fittings has been discouraged. This is because the risks associated with introducing a compressible gas at elevated pressure above atmospheric into the system. Dangerous conditions can arise by pressurizing with gas if dry fits are present. Dangerous conditions can occur because the pressure may cause the dry fit to release suddenly with substantial force. Fittings, sprinkler heads or other items may then become projectiles which can cause damage to persons or property. This is why leak testing is conventionally done with incompressible fluid such as water, to reduce these risks.

In the exemplary embodiment, the apparatus includes the pressure relief valve to avoid the introduction of pressures into the system that are sufficiently high so as to cause dry fits to separate with potentially dangerous force. In the exemplary embodiment, the pressure relief valve is set to release at approximately 30 PSIG. The 30 PSIG setting is exemplary and other settings can be used, such as 20 PSIG, if desired. The setting should be higher than the test pressure. Relieving the pressure at this level, or at a level appropriate for the particular system, substantially reduces the risk of high velocity separation of dry fits. Thus, in the exemplary embodiment, leaks can be determined and corrected more readily while minimizing the risk of dangerous conditions.

Of course these approaches are exemplary and in other embodiments other approaches applying these principles may be used.

### BRIEF DESCRIPTION OF DRAWINGS

FIG. 1 is a schematic view of a fluid handling system which in this exemplary embodiment includes a fire suppression sprinkler system.

FIG. 2 is an enlarged view of an exemplary apparatus used in testing for leaks in such a fluid handling system.

### DETAILED DESCRIPTION OF EXEMPLARY EMBODIMENTS

The invention will be described more completely below in the exemplary embodiment of a fire sprinkler system using CPVC pipes and fittings cemented together with solvent cement. Any suitable adhesive could be used to cement the pipe and fittings together. Also, other types of pipe and fittings, other than CPVC, can be used with this invention as well as other fluid handling systems other than fire sprinkler systems. For example, the invention is applicable to PVC piping systems, PEX piping systems, composite pipe systems, and metal piping systems, as well as any other piping systems where pipe lengths must be joined together in a fluid tight manner. Although solvent cementing is the most common method of joining CPVC and PVC pipes and fittings, any appropriate adhesive is applicable, such as epoxy adhesives. The apparatus of this invention would also be applicable to metal piping systems, which use threaded connections to fittings or other items in the systems.

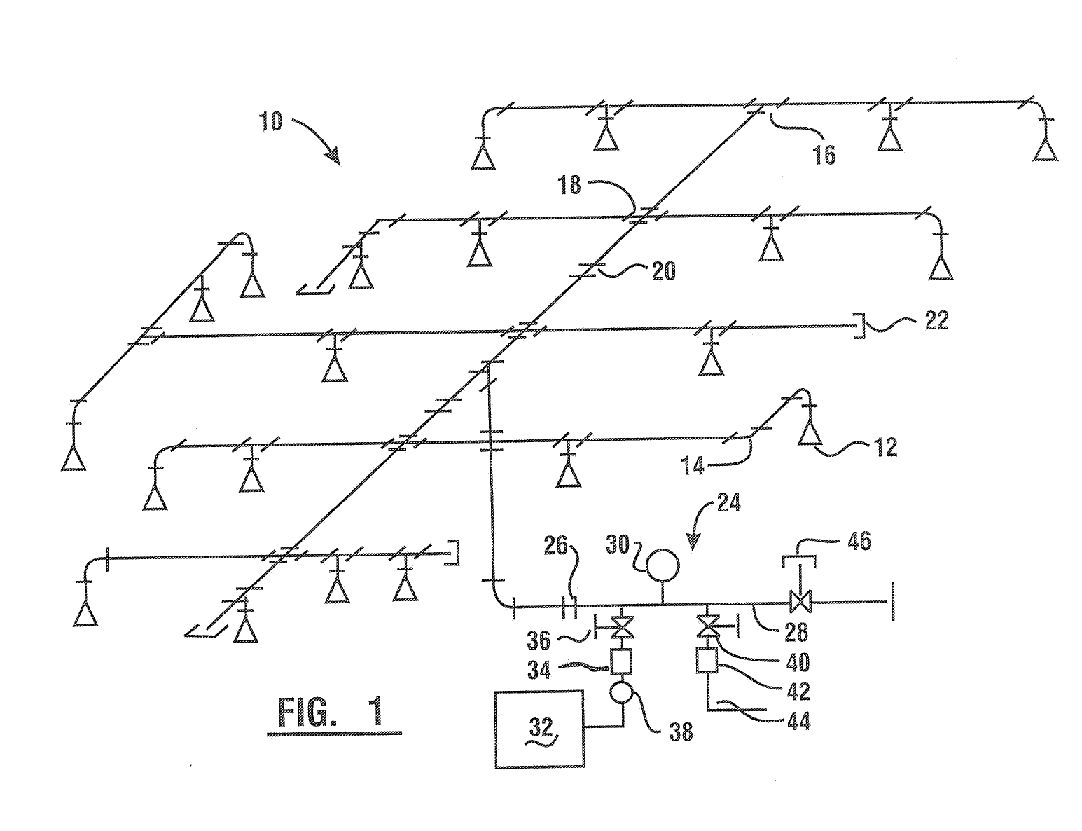

Referring now to the drawings and particularly to FIG. 1, there is shown therein schematically an exemplary fluid handling system generally indicated 10. The exemplary fluid handling system comprises a fire suppression sprinkler system that operates to deliver water to areas of a building where a fire is occurring. The system 10 includes a plurality of sprinkler heads 12. Sprinkler heads 12 may be of the type that includes a valve mechanism that detects excessive heat in the area of the head that causes the sprinkler head to open and deliver water from the system through the head. Such mechanisms may include, for example, bi-metal discs that deform in response to excessive heat, materials that melt in response to heat or structures that change in ways in response to excessive heat that cause the valve included in the sprinkler head to open. It should be understood that various types of sprinkler heads can be used. Further, in the normal condition of the sprinkler head, the valve in each head remains closed until such time as excessive heat causes the sprinkler head to open. In many cases once a sprinkler head has opened, the head or at least components thereof need to be replaced in order to place the system back in service.

The exemplary fluid handling system is comprised of plastic pipes and fittings. The exemplary pipe fittings used are comprised of CPVC material suitable for use in fire suppression systems. Such pipes and fittings are sold under the trademark BlazeMaster® which is a material available from Lubrizol Advanced Materials, Inc. Often in exemplary embodiments such CPVC pipe has a continuous phase of CPVC polymer that has more than 50 percent of the volume of the polymer as components of CPVC, and preferably more than 70 and/or more than 80 percent. Of course other polymers can be combined with CPVC polymer for improving properties such as impact resistance, flow enhancers and other properties. However, these other polymers and other materials are used in smaller amounts normally from about 5 to 15 percent by weight. It should be understood that this type of system and material is exemplary and in other embodiments other systems and materials may be used.

In the exemplary fluid handling system which is used with fire suppression sprinklers, the piping system is formed by joining pipe segments and a plurality of fittings together in sealed fluid tight relation. This is preferably done using suitable solvent cements. Certain types of fittings are shown in the exemplary system including for example elbows 14, tees 16, crosses 18, couplings 20, caps and plugs 22. Further in the exemplary embodiment, the sprinkler heads which are comprised of metallic material are joined in threaded engagement to couplings which have a CPVC body which can be joined in cemented engagement to the system. The exemplary couplings that connect to the sprinkler heads include a metal insert to provide sealed threaded engagement to the inlet port of a sprinkler head. Of course these fittings and structures are exemplary and in other embodiments other approaches may be used.

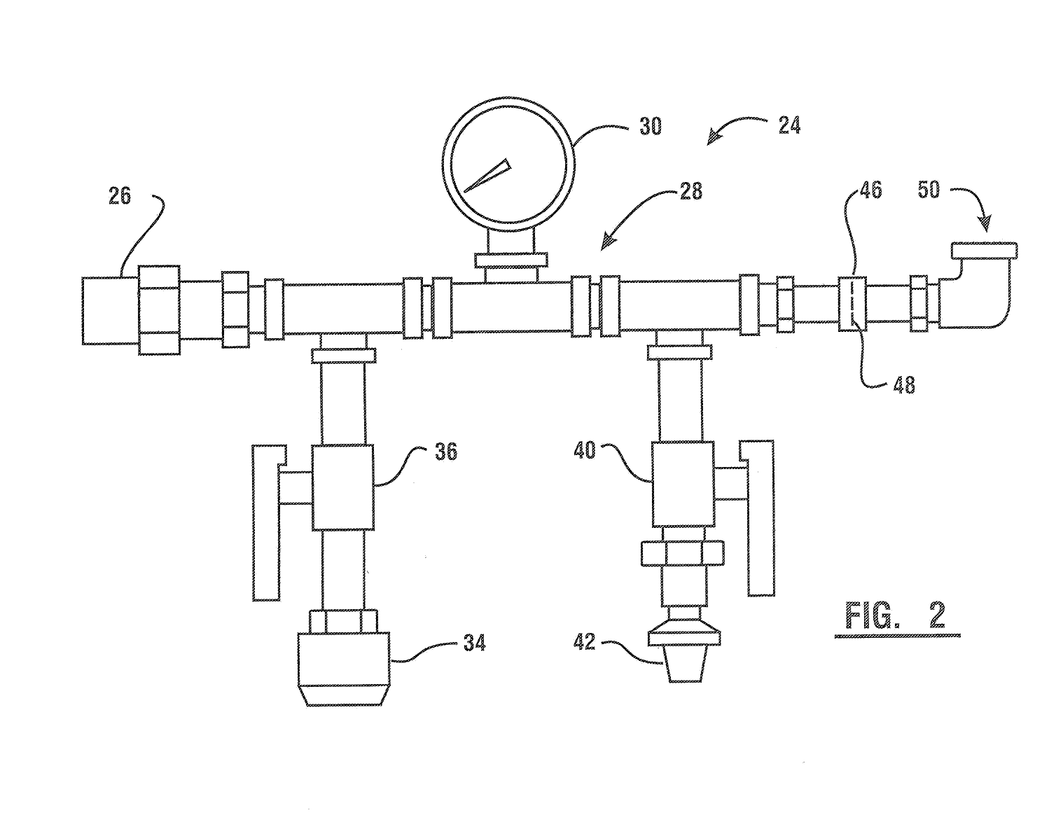

In the exemplary embodiment, testing of the system may be accomplished using an apparatus schematically represented 24 and shown in greater detail in FIG. 2. Apparatus 24 is releasibly connected to the piping system through a system coupling schematically indicated 26. The system coupling is in fluid communication with a fluid conduit 28. In the exemplary embodiment, the fluid conduit 28 is comprised of a plurality of connected tee fittings which provide a common fluid chamber in communication with the system coupling. In the exemplary embodiment, the fittings which comprise the fluid conduit are comprised principally of brass. Of course this approach is exemplary and in other embodiments other approaches may be used.

The fluid conduit is in fluid communication with a pressure indicator 30. In the exemplary embodiment, the pressure indicator includes a gauge which provides a visual indication of the pressure in the fluid conduit above the level of atmospheric pressure. Of course when the fluid conduit is fluidly connected to the system, the pressure indicator indicates the pressure applied to the system as well. It should be understood that in other embodiments electronic indicators or other suitable pressure sensing devices may additionally or alternatively be used.

The fluid conduit is also in communication with a source of pressurized gas 32. The source of pressurized gas may include an air compressor, gas bottle or other suitable source. The source of pressurized gas provides a sufficient volume of gas at a pressure above atmospheric to pressurize the piping system to a suitable test pressure in a manner as later discussed. In an exemplary embodiment, the source of pressurized gas provides air at a pressure above atmospheric. Of course, in other embodiments, other approaches may be used.

The source of pressurized gas is fluidly connected to the fluid conduit 28 through a pressure coupling 34. Pressure coupling 34 in the exemplary embodiment is a releasable coupling which enables the gas source to be releasibly connected to the fluid conduit. The pressure conduit may in various embodiments, include a hose coupling, pipe or tube coupling or other suitable coupling to conduct pressurized gas from the source to the fluid conduit. Further, in some embodiments, the pressure coupling may include an internal valve which operates to block air flow outward from the fluid conduit when the pressure of gas source is relieved or disconnected therefrom. Of course these approaches are exemplary and in other embodiments other approaches may be used.

The exemplary apparatus 24 further includes a valve 36. Valve 36 is positioned fluidly intermediate of the pressure coupling 34 and the fluid conduit 28. In the exemplary embodiment, valve 36 is a manual valve that can be selectively opened and closed. For example, the valve can be opened to allow gas from the gas source to flow into the fluid conduit and the system. Valve 36 may be closed to isolate the fluid conduit from the coupling 34 and/or the fluid source and conduits. Of course it should be understood that in other embodiments, other types of valve structures including other types of two-way, three-way and four-way valves may be used for purposes of carrying out the functions described herein.

In the exemplary embodiment, a filter separator schematically indicated 38 is fluidly positioned between the source of pressurized gas and the fluid conduit. In the exemplary system which is comprised of CPVC pipes and fittings, adverse effects can result from contact of the material with petroleum lubricants and certain other types of contaminants. The filter separator of the exemplary embodiment operates to trap oils and other contaminants in the pressurized air so as to prevent them from reaching the fluid conduit. In addition, some embodiments of the filter separator may include desiccant materials or other filtration type materials that are suitable for capturing contaminants including water or other materials so as to avoid their introduction into the fluid conduit and the piping system. It should be understood that the particular type of filter separator used will depend on the requirements of the system and the particular potential contaminants which may emanate from the source of pressurized gas.

The exemplary apparatus 24 further includes a valve 40. Valve 40 is in fluid connection with the fluid conduit 28. In the exemplary embodiment, valve 40 is a manual two-way valve. Of course it should be understood that in other embodiments other types of valves may be used. Valve 40 is manually actuatable to fluidly connect the fluid conduit with a release coupling 42. In the exemplary embodiment, the release coupling 42 is releasably connectable to a hose or other conduit that is operative to conduct air out of the system, the conduit and through the valve 40 to relieve pressure that is used in pressure testing. In FIG. 1, such a hose is schematically represented 44. Of course it should be understood that these structures are exemplary and in other embodiments, other structures may be used.

The fluid conduit 28 is also in fluid communication with a pressure relief valve 46. The pressure relief valve is operative to release pressure in the fluid conduit that is above the limit. In the exemplary embodiment, the pressure relief valve is operative to release pressure above approximately 30 PSIG. The limit of 30 PSIG has been determined to be a pressure above which dangerous conditions might occur due to dry fits or other defects in the assembly of CPVC sprinkler systems. Of course in other embodiments other pressure limits may be used. For example, 20 PSIG could be the set limit, where the test pressure is 15 PSIG.

In the exemplary embodiment, the pressure relief valve includes a frangible member schematically indicated 48. The frangible member operates to break when the pressure in the fluid conduit reaches and/or exceeds the limit. The breaking of the frangible member relieves the pressure from the fluid conduit. In the exemplary embodiment, the frangible member comprises a burst disc that breaks at the limit. Of course, in other embodiments, other types of frangible members may be used. Further, it should be understood that other types of pressure relief valves can also be used in connection with certain embodiments. Such pressure relief valves may include pop off valves, spring loaded valves, regulator valves or other suitable valves that serve to assure that pressure used in testing the system does not exceed a limit. Of course it should be understood that generally such pressure relief valves operate to relieve pressure at approximately the limit and/or within a range that is sufficiently close to the limit so as to avoid damage or dangerous conditions.

In the exemplary embodiment if the pressure relief valve releases pressure, the pressure exits through a diffuser 50. In the exemplary embodiment, the diffuser operates to avoid a directed rush of air as a result of the pressure relief valve releasing the pressure. In the embodiment shown, the diffuser is a fluid conduit that redirects the air 90 degrees from the central axis of the fluid conduit. The exemplary diffuser directs the air upward so as to reduce the risk that the air will exhaust and apply force against persons or property in the ways that cause damage. It should be understood that in other embodiments other types of diffusers may be used. Such diffusers will often operate to redirect the flow in a manner that reduces the risk of a high velocity flow directed in a particular direction that might cause damage to persons or property. Diffusers may include for example, fittings that include multiple fluid outlets facing in multiple different directions through which air may exhaust. Alternatively, diffusers may include filters, screens, mufflers or other devices that operate to minimize the risk of damaging fluid flow. Of course these approaches are exemplary.

In an exemplary application of the principles described herein, a fluid handling system is assembled by an installer or other individual. The installer commonly cuts the CPVC pipes to each desired length and assembles the fittings for survey and evaluation purposes. Such assembly generally includes making initial dry fits without using solvent cement. This enables the installer to determine if the pipe and fittings are the proper length and conform to the plans for the system. In the event that the initial test assembly with dry fits shows a need to make revisions, an installer can then readily disassemble the fittings and pipe segments and make any changes or additions as may be required.

Once the system has been assembled using dry fits and appears to be satisfactory, the installer will then begin disassembling, cementing and reassembling the fittings and pipe segments in engaged relation. This is done using solvent cement. The installer will commonly separate the fittings and pipe segments, apply the solvent cement to the exterior of the end of the pipe segment that will extend in the fitting and to the interior of the fitting. The installer will then insert the end of the pipe segment with cement thereon into the pipe and/or fitting while also turning the pipe or fitting to a final desired position. This serves to assure that the solvent cement is properly spread within the area of the joint in order to make a proper and fluid tight cemented connection. The installer will repeat this process to assure that the plurality of plastic fittings are all joined in cemented connection in the system. Also, as discussed, sprinkler heads or other components that are connected through threaded engagement with couplings or other suitable fittings or devices, are assembled into the system so as to create a generally fluid tight piping system. Of course, as can be appreciated, regardless of the efforts made by the installer to assure that all joints are properly cemented and fluid tight, sometimes dry fits that remain uncemented will be overlooked.

After the installer has joined the pipe segments and fittings into the fluid handling system, the installer will then wait the recommended cure time for the solvent cement as necessary to allow it to cure. This assures that the sealed connections are properly made. Of course as can be appreciated, the cure time will often vary depending on the nature of the material, the solvent cement, the size of the connections being made as well as the ambient temperature and humidity.

After waiting at least the appropriate cure time, the system can then be tested using the apparatus 24. The system coupling 26 is joined in fluid tight relation with the piping system at a suitable location as shown in FIG. 1. The source of pressurized gas 32 is connected to the pressure coupling 34. The valve 36 is opened to enable air above the ambient atmospheric pressure to pressurize the fluid conduit 28 and the piping system 10. Air is allowed to flow into the system until the system and the pressure in the fluid conduit 28 reach a suitable test pressure. In exemplary embodiments, a suitable test pressure has been found to be approximately 15 PSIG. Of course this test pressure is exemplary and in other embodiments, other pressures may be used. Of course the test pressure is desirably below the limit of the pressure relief valve.

After the system has been pressurized to the desired test pressure, the valve 36 is closed so as to separate the fluid conduit from the source of pressurized gas and other structures that may introduce or release gas from the system. Of course as the system is pressurized, the valve 40 and the pressure relief valve 46 usually remain closed.

The pressure indicator 30 is then observed over a test time period to determine if the system is holding pressure. The test time will depend on the particular system and the specifications for the particular system. Test times may vary between a matter of hours and one or more days. If air pressure is leaking from the system, it will be apparent as the pressure indicator 30 shows the pressure dropping from the initial test pressure. In cases where pressure is leaking, the source of the leak may be found by the techniques previously described. This may include, for example, the use of listening devices, leak test solutions, or other suitable items which can identify where a leak is occurring. Of course as previously discussed in the event that there are dry fits associated with any of the fittings, the pressurized air will generally escape through such a dry fit. This will occur even in circumstances where often a water test will not produce a leak.

If leaks are found due to the pressure indicator indicating a reduction in test pressure during the test, the leaks are located and fixed. The testing can then be redone. This process is repeated until all the leaks are found and fixed.

In situations where a test is to be concluded, pressure can be released from the system by opening the valve 40. Opening the valve 40 relieves pressure in the system and from the fluid conduit through a hose 44. Relieving the pressure brings the fluid conduit and the pressure in the system back to ambient atmospheric pressure.

As can be appreciated in the event of a malfunction or operator error, the fluid conduit and thus the system may be pressurized in excess of the desired test pressure. If this occurs the pressure relief valve 46 reduces the risk that any damage may occur. This is because the pressure relief valve relieves pressure above 30 PSIG. Indeed, in the exemplary embodiment when the limit of 30 PSIG is reached, the frangible member bursts and pressure is exhausted from the system. Of course the apparatus 24 can be placed back in service by replacing the frangible member in the pressure relief valve.

It should be appreciated that the arrangement of the apparatus described is exemplary and that different types of valving, pressure indicating devices and pressure relief arrangements may be used while still employing the principles described herein. Further various types of materials may also be substituted for those described in connection with the exemplary embodiment. Further, in some embodiments, the testing process may be automated such as through the use of electrically actuated valves and through the use of electronic pressure indicators to monitor the pressure within the system. In some embodiments, one or more processors may be suitably programmed to control the valves and monitor the pressure to detect leaks. Further, such systems may operate to conduct repeated tests automatically to provide higher assurance that no leaks are present. Further, in some embodiments, additional devices may be incorporated into the apparatus. These may include, for example, enunciators which operate to provide audible, visual or other indications in the event that the test pressure falls below a particular setting. Alternatively, such sensors and indicators may operate to provide an audible, visual or other indication that the pressure is approaching the limit. Various approaches may be used depending on the particular apparatus and system.

Thus, the exemplary apparatus and methods achieve one or more of the above stated objectives, and produce at least some of the useful results described.

In the foregoing description, certain terms have been used for brevity, clarity and understanding. However, no unnecessary limitations are to be implied therefrom because such terms are used for descriptive purposes and are intended to be broadly construed. Moreover, the descriptions and illustrations herein are by way of examples and the invention is not limited to the exact details shown and described.

In the following claims any feature described as a means for performing a function shall be construed as encompassing any means known to those skilled in the art to be capable of performing the recited function, and will not be deemed limited to the features and structures shown herein or mere equivalents thereof. The description of the exemplary embodiment included in the Abstract or otherwise set forth herein shall not be deemed to limit the invention to the features described herein.

Having described the features, discoveries and principles of the invention, the manner in which it is constructed and operated, and the advantages and useful results obtained; the new and useful structures, devices, elements, arrangements, parts, combinations, systems, equipment, operations, reference and relationships are set forth in the appended claims.

1. Fluid handling apparatus comprising:
a fluid conduit;
a system coupling in fluid communication with the conduit, wherein the system coupling is configured to releasibly connect to a generally fluid tight piping system including a plurality of fittings joined in the system in fluid tight relation;
a pressure coupling in fluid communication with the conduit, wherein the pressure coupling is configured to fluidly connect to a source of pressurized gas at a pressure above atmospheric;
a pressure relief valve in fluid communication with the conduit, wherein the pressure relief valve is operative to relieve pressure above a limit from the conduit;
a pressure indicator in fluid communication with the conduit, wherein the pressure indicator is operative to indicate pressure in the conduit;
wherein the pressure coupling is usable to pressurize the piping system with gas to at least one test pressure above atmospheric and below the limit, and the pressure indicator is operative to indicate whether the piping system holds the at least one test pressure for a test time period, wherein failure to hold the at least one test pressure for the test time period is indicative that there is at least one non fluid tight fitting in the piping system.

2. The apparatus according to claim 1, and further comprising:
a manually actuatable valve in fluid communication with the conduit and atmospheric pressure, wherein the valve is selectively operative to selectively relieve the at least one test pressure to atmosphere.

3. The apparatus according to claim 2, and further comprising:
a further valve in fluid communication with the conduit, wherein the further valve is selectively operative to fluidly separate the source of pressurized gas and the conduit.

4. The apparatus according to claim 3, wherein the pressure relief valve includes a frangible member, wherein the frangible member breaks at about the limit.

5. The apparatus according to claim 3, wherein the piping system comprises at least one fire sprinkler head.

6. The apparatus according to claim 5, wherein the at least one fitting is a plastic fitting comprised of chlorinated polyvinyl chloride (CPVC).

7. The apparatus according to claim 6, wherein the at least one plastic fitting comprises at least one of a tee, a union, a coupling, a cross, an elbow, a plug and a cap.

8. The apparatus according to claim 7 and further comprising the piping system.

9. The apparatus according to claim 7 and further comprising the source of pressurized gas, wherein the source of pressurized gas includes a source of pressurized air.

10. The apparatus according to claim 9 and further comprising a filter separator, wherein the filter separator is operative to remove at least one of petroleum material and water, and wherein the filter separator is fluidly intermediate of the source of pressurized air and the conduit.

11. The apparatus according to claim 7 and further comprising:
a release coupling, wherein the release coupling is in fluid communication with the manually actuatable valve, wherein the release coupling is operatively releasibly connectable to a conduit that connects to atmosphere.

12. The apparatus according to claim 7 and further comprising:
a diffuser, wherein the diffuser is in fluid connection with the pressure relief valve, and wherein the diffuser is fluidly intermediate of the pressure relief valve and atmosphere.

13. The apparatus according to claim 7 wherein the frangible member of the pressure relief valve comprises a burst disc.

14. The apparatus according to claim 13 wherein the burst disc is configured to break at approximately 30 PSIG or 20 PSIG.

15. The apparatus according to claim 7 wherein the at least one test pressure is approximately 15 PSIG.

16. The apparatus according to claim 1 wherein the piping system comprises at least one sprinkler head, and wherein the plurality of fluid couplings are comprised of CPVC.

17. A method comprising:
(a) operatively connecting in fluid communication a fluid handling apparatus and a system,
wherein the apparatus includes
a fluid conduit,
a releasable system coupling in fluid communication with the fluid conduit, wherein the apparatus is fluidly connected to the system through the system coupling,
a pressure coupling, wherein the pressure coupling is in fluid communication with the fluid conduit and is configured for connection to a source of pressurized gas,
a pressure relief valve in fluid communication with the conduit, wherein the pressure relief valve is operative to release pressure above a limit from the conduit,
a pressure indicator in fluid communication with the conduit, wherein the pressure indicator is operative to indicate fluid pressure in the conduit,
wherein the system comprises a generally fluid tight piping system including a plurality of fittings and pipes joined in fluid tight relation in the system,
(b) pressurizing the piping system to a test pressure with gas through the pressure coupling from the source of pressurized gas, wherein the test pressure is above atmospheric and below the limit;
(c) subsequent to (b) preventing fluid flow into or out of the fluid conduit for a test time period, wherein the pressure indicator is operative to indicate whether the piping system is holding the test pressure during the test time period, and whereby a failure to hold the test pressure for at least the test time period is indicative of at least one probable non fluid tight fitting in the piping system.

18. The method according to claim 14,
wherein the apparatus further comprises a manually actuatable valve in fluid connection with the conduit and atmosphere,
wherein in (c) the manually actuatable valve is in a closed condition,
and further comprising:
(d) subsequent to the test time period, opening the manually actuatable valve to relieve the test pressure to atmosphere.

19. The method according to claim 18,
wherein the apparatus further includes a further valve, wherein the further valve is fluidly intermediate of the pressure coupling and the conduit,
and wherein (b) includes operating the further valve to pressurize the system to the test pressure, and wherein (c) includes closing the further valve.

20. The method according to claim 19 wherein the limit of the pressure relief valve is approximately 30 PSIG,
and wherein in (b) the test pressure is below 30 PSIG.

21. The method according to claim 20 wherein in (b) the test pressure is approximately 15 PSIG.

22. The method according to claim 19 wherein the pressure relief valve comprises a frangible member, wherein the frangible member breaks to release pressure from the system at approximately 30 psig,
wherein in (b) the test pressure is below 30 PSIG.

23. The method according to claim 19,
wherein prior to (a), assembling the piping system, wherein the piping system includes a plurality of plastic fittings and pipes comprised of CPVC, wherein the fittings are joined to the pipe in the piping system in cemented relation, and wherein the piping system further includes a plurality of sprinkler heads,
and wherein subsequent to (c) and responsive to the piping system not holding the test pressure for at least the test time period, cementing at least one fitting in joined connection in the system, wherein the at least one fitting was previously connected in the system in uncemented relation.
